(19) United States
(12) Patent Application Publication
(10) Pub. No.: US 2024/0321232 A1
(43) Pub. Date: Sep. 26, 2024

(54) SOURCE DRIVER AND DISPLAY APPARATUS

(71) Applicant: LAPIS Technology Co., Ltd., Yokohama (JP)

(72) Inventor: Yuki Akiyama, Yokohama (JP)

(21) Appl. No.: 18/609,588

(22) Filed: Mar. 19, 2024

(30) Foreign Application Priority Data
Mar. 20, 2023 (JP) 2023-044058

(51) Int. Cl. G09G 3/36

(52) U.S. Cl. CPC G09G 3/3688; G09G 2310/0291; G09G 2320/0233

(57) ABSTRACT

A source driver includes a gradation wiring, a plurality of output amplifiers, a gradation voltage generation unit, a bias current supply unit, a comparison unit, and a bias current adjustment unit. The plurality of output amplifiers are arranged side by side in parallel with the gradation wiring. The gradation voltage generation unit is disposed in a center region located close to a center portion of a driver IC. The bias current supply unit is disposed in the center region. The comparison unit compares the pixel drive voltages output from each of a first output amplifier and a second output amplifier disposed at opposed positions across the center region among the plurality of output amplifiers. The bias current adjustment unit adjusts at least one of the bias current supplied to each of the first output amplifier and the second output amplifier based on a comparison result.

### CROSS-REFERENCE TO RELATED APPLICATION

This application is based upon and claims the benefit of priority from the prior Japanese Patent Application No. 2023-044058 filed on Mar. 20, 2023, the entire contents of which are incorporated herein by reference.

### BACKGROUND

### 1. Technical Field

The disclosure relates to a source driver and a display apparatus.

### 2. Description of the Related Art

An active matrix drive system is employed as a drive system for a display apparatus constituted of a display device such as a liquid crystal or an Organic Light Emitting Display (OLED). In the display apparatus of the active matrix drive system, a display panel is constituted of a semiconductor substrate where pixel portions and pixel switches are arranged in a matrix. A display is performed by controlling on/off of a pixel switch by a gate signal, supplying a gradation voltage signal corresponding to a video data signal to the pixel portion when the pixel switch is turned on, and controlling luminance of the respective pixel portions.

A supply of the gradation voltage signal to the pixel portions is performed by a source driver via data lines. A driver Integrated Circuit (C) constituting a source driver is provided with a plurality of output amplifiers that output pixel drive voltages and a gradation voltage generation circuit that generates gradation voltages, which are the basis of the pixel drive voltages, to supply them to each of the plurality of output amplifiers. The gradation voltage generation circuit is disposed, for example, in a region of a center portion located close to a center portion of the driver IC, and supplies the gradation voltages to each output amplifier via a gradation wiring (for example, JP-A-2021-89402).

Although the gradation voltage generation circuit as described above is disposed in the region of the center portion of the driver IC, it is not necessarily disposed exactly in the middle position in relation to the gradation wiring. For this reason, lengths of the gradation wirings connecting the output amplifiers located on the left and right sides across the region of the center portion of the driver IC to the gradation voltage generation circuit are different on the left and right sides, in some cases. In this case, due to an electrical resistance difference and a capacitance difference of the gradation wirings, a time difference (an output delay difference) occurs in the output of the pixel drive voltages from each output amplifier. Due to this output delay difference, a difference in achieved electric potential between channels when the pixel drive voltages are applied to the pixel portions occurs, thus resulting in a problem of occurrence of display unevenness.

The disclosure has been made in consideration of the above-described problem, and it is an object of the disclosure to provide a source driver that can suppress the occurrence of the display unevenness in a channel direction of a display panel.

### SUMMARY

According to the disclosure, a source driver connected to a display panel having a plurality of source lines and a plurality of pixel portions connected to the plurality of source lines, the source driver receiving a video data signal including a series of a plurality of pixel data pieces and outputting pixel drive voltages applied to the plurality of pixel portions based on the video data signal, the source driver comprises: a gradation wiring extending in a first direction; a plurality of output amplifiers arranged side by side in parallel with the gradation wiring along the first direction, the output amplifiers receiving supply of gradation voltages via the gradation wiring, generating the pixel drive voltages based on the video data signal and the gradation voltages, and outputting to the plurality of source lines; a gradation voltage generation unit that is disposed in a center region located close to a center portion of a driver IC constituting the source driver and generates the gradation voltages to output to the gradation wiring; a bias current supply unit that is disposed in the center region and supplies bias currents to the plurality of output amplifiers; a comparison unit that compares the pixel drive voltages output from each of a first output amplifier and a second output amplifier disposed at opposed positions across the center region among the plurality of output amplifiers; and a bias current adjustment unit that adjusts at least one of the bias current supplied to the first output amplifier and the bias current supplied to the second output amplifier based on a comparison result of the comparison unit.

According to the disclosure, a display apparatus comprises: a display panel having a plurality of source lines and a plurality of source lines, and a plurality of pixel portions disposed in a matrix at respective intersecting portions between the plurality of source lines and the plurality of source lines; and a source driver that receives a video data signal including a series of a plurality of pixel data pieces and outputs pixel drive voltages applied to the plurality of pixel portions based on the video data signal, wherein the source driver includes: a gradation wiring extending in a first direction; a plurality of output amplifiers arranged side by side in parallel with the gradation wiring along the first direction, the output amplifiers receiving supply of gradation voltages via the gradation wiring, generating the pixel drive voltages based on the video data signal and the gradation voltages, and outputting to the plurality of source lines; a gradation voltage generation unit that is disposed in a center region located close to a center portion of a driver IC constituting the source driver and generates the gradation voltages to output to the gradation wiring; a bias current supply unit that is disposed in the center region and supplies bias currents to the plurality of output amplifiers; a comparison unit that compares the pixel drive voltages output from each of a first output amplifier and a second output amplifier disposed at opposed positions across the center region among the plurality of output amplifiers; and a bias current adjustment unit that adjusts at least one of the bias current supplied to the first output amplifier and the bias current supplied to the second output amplifier based on a comparison result of the comparison unit.

### BRIEF DESCRIPTION OF THE DRAWINGS

Features of the disclosure will be described below with reference to the accompanying drawings.

FIG. 1 is a block diagram illustrating a configuration of a display apparatus according to the disclosure;

FIG. 2 is a circuit diagram illustrating a configuration of a source driver;

FIG. 3 is a circuit diagram illustrating a configuration of a comparison unit and adjacent output amplifiers of Embodiment 1;

FIG. 4 is a diagram illustrating operation waveforms of output voltages of Embodiment 1;

FIG. 5 is a circuit diagram illustrating a configuration of a comparison unit and adjacent output amplifiers of Embodiment 2; and

FIG. 6 is a diagram illustrating operation waveforms of output voltages of Embodiment 2.

### DETAILED DESCRIPTION

With the source driver according to the disclosure, it is possible to suppress the occurrence of the display unevenness in the channel direction of the display panel.

The following describes embodiments of the disclosure with reference to the attached drawings. In the following description and attached drawings in each embodiment, the same reference numbers are given to substantially identical or equivalent parts.

### Embodiment 1

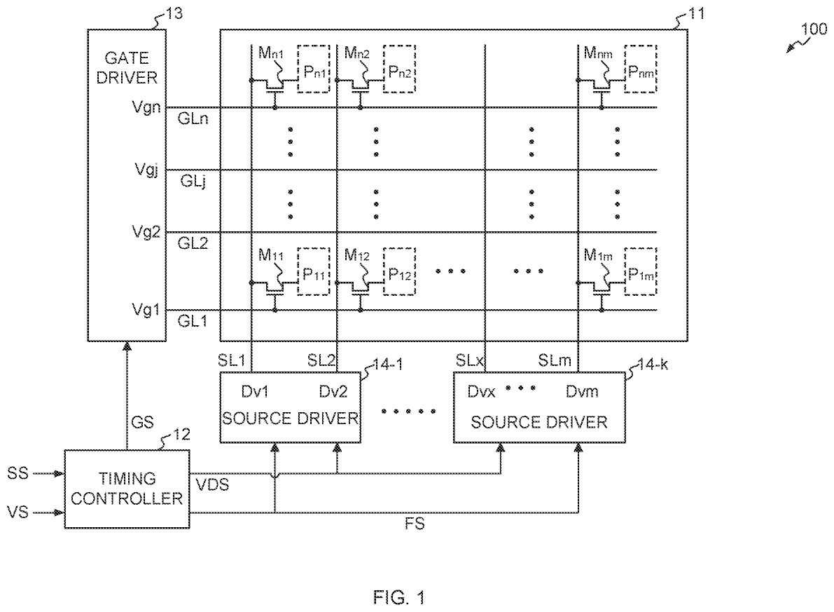

FIG. 1 is a block diagram illustrating a configuration of a display apparatus 100 according to Embodiment 1 of the disclosure. The display apparatus 100 is a liquid crystal display apparatus of an active matrix drive system. The display apparatus 100 includes a display panel 11, a timing controller 12, a gate driver 13, and source drivers 14-1 to 14-k.

The display panel 11 is constituted of a semiconductor substrate where a plurality of pixel portions P₁₁ to Pₙₘ and a plurality of pixel switches M₁₁ to Mₙₘ (n, m: natural numbers equal to or more than 2) are arranged in a matrix. The display panel 11 includes n gate lines GL1 to GLn that are scanning lines each of which extends in a horizontal direction and m source lines SL1 to SLm that are disposed so as to intersect with the n gate lines GL1 to GLn. The pixel portions P₁₁ to Pₙₘ and the pixel switches M₁₁ to Mₙₘ are disposed at intersecting portions of the gate lines GL1 to GLn and the source lines SL1 to SLm.

The pixel switches M₁₁ to Mₙₘ are controlled to be turned on or off corresponding to gate signals Vg1 to Vgn supplied from the gate driver 13.

The pixel portions P₁₁ to Pₙₘ receive supply of gradation voltages (drive voltages) corresponding to video data from the source drivers 14-1 to 14-k. Specifically, pixel drive voltage signals Vd1 to Vdm are output to the source lines SL1 to SLm from the source drivers 14-1 to 14-k, and the pixel drive voltage signals Vd1 to Vdm are applied to the pixel portions P₁₁ to Pₙₘ when the respective pixel switch M₁₁ to Mₙₘ are turned on. This charges each pixel electrode of the pixel portions P₁₁ to Pₙₘ and controls luminance.

Each of the pixel portions P₁₁ to Pₙₘ includes a transparent electrode connected to the source lines SL1 to SLm via the pixel switches M₁₁ to Mₙₘ and a liquid crystal sealed between the transparent electrode and an opposed substrate that is disposed opposed to a semiconductor substrate and on an entire surface of which one transparent electrode is formed. The display is performed by changing transmittance of the liquid crystal with respect to a backlight inside the display apparatus in response to an electric potential difference between the gradation voltage (the drive voltage) applied to the pixel portions P₁₁ to Pₙₘ and a voltage of the opposed substrate.

The timing controller 12 generates a series of pixel data pieces PD (a serial signal) indicating a luminance level of each pixel in, for example, 256-steps of 8-bit luminance gradation, based on video data VS. The timing controller 12 generates a clock signal CLK of an embedded clock system having a constant clock cycle based on a synchronization signal SS. The timing controller 12 generates a video data signal VDS a serial signal in which the series of pixel data pieces PD and the clock signal CLK are integrated, and supplies it to the source drivers 14-1 to 14-k to perform a display control of the video data. The video data signal VDS is constituted as the video data signal serialized corresponding to the number of transmission paths for each predetermined number of source lines.

In the embodiment, the video data signal VDS for one frame is constituted by serially continuing n pixel data piece groups, each of which is constituted of m pixel data pieces PD. Each of the n pixel data piece group is a pixel data piece group constituted of the pixel data piece corresponding to the gradation voltage to be supplied to the pixels on one horizontal scanning line (namely, each of the gate lines GL1 to GLn), respectively. By operations of the source drivers 14-1 to 14-k, based on m×n pixel data pieces PD, the pixel drive voltage signals Vd1 to Vdm to be supplied to the n×m pixel portions (namely, the pixel portions P₁₁ to Pₙₘ) are supplied via the source lines.

Based on the synchronization signal SS, the timing controller 12 generates a frame synchronizing signal FS indicating a timing for each one frame of the video data signal VDS and supplies it to the source drivers 14-1 to 14-k. The timing controller 12 generates a gate control signal GS that controls an operation of the gate driver 13, and supplies it to the gate driver 13.

The gate driver 13 operates by receiving a supply of the gate control signal GS from the timing controller 12, and sequentially supplies the gate signals Vg1 to Vgn to the gate lines GL1 to GLn based on a clock timing included in the gate control signal GS. By the supply of the gate signals Vg1 to Vgn, the pixel portions P₁₁ to Pₙₘ are selected for each pixel row. Then, by the pixel drive voltage signals Vd1 to Vdm being applied to the selected pixel portions from the source drivers 14-1 to 14-k, write of the gradation voltage to the pixel electrodes is performed.

In other words, by the operation of the gate driver 13, m pixel portions arranged along an extension direction of the gate line (namely, laterally in one row) are selected as a supply target of the pixel drive voltage signals Vd1 to Vdm. The source drivers 14-1 to 14-k apply pixel drive voltage signals Vd1 to Vdm to the selected pixel portions in one lateral row, and causes a color corresponding to the voltage to be displayed. By repeating this process in the extension direction (namely, a longitudinal direction) of the source lines while selectively switching one lateral row of pixel portions selected as the supply target of the pixel drive voltage signals Vd1 to Vdm, a screen display for one frame is performed.

Since the pixel drive voltage signals Vd1 to Vdm are data signals output from the source drivers 14-1 to 14-k, they are also referred to as data signals Vd1 to Vdm in the following description.

The source drivers 14-1 to 14-k are disposed for every predetermined number of data lines obtained by dividing the source lines SL1 to SLm. The source drivers 14-1 to 14-k are formed on separate semiconductor Integrated Circuit (IC) chips. For example, when each source driver has 960 outputs and the display panel includes one data line for each pixel column, the source lines are driven by 12 source drivers for a 4K panel and 24 source drivers for an 8K panel. The source drivers 14-1 to 14-k each receive supply of a serial signal in which a control signal CS, the clock signal CLK, and the video data signal VDS are integrated from the timing controller 12 through separate transmission paths. When there is one pair (two lines) of transmission paths between the timing controller 12 and each source driver, during one data period, the video data VS and control signals CS for the number of outputs of the source driver are supplied as serialized differential signals.

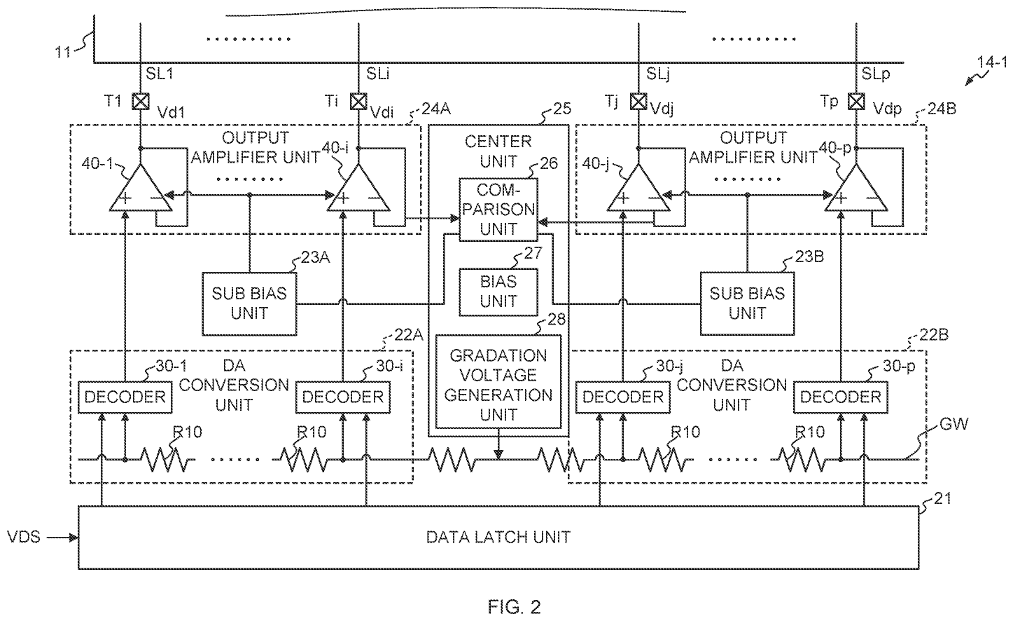

FIG. 2 is a block diagram illustrating an internal configuration of the source driver 14-1. Other source drivers 14-2 to 14-k also have similar configurations.

The source lines SL1 to SLp are indicated by extracting only the source lines driven with an identical polarity (for example, a positive polarity) from among the source lines to which the source driver 14-1 is responsible for supplying the gradation voltages. Accordingly, source lines (not illustrated) that are actually driven with an opposite polarity (for example, a negative polarity) are disposed between the adjacent source lines of the source lines SL1 to SLp. Accordingly, in FIG. 2, though the source line SLi and the source line SLj are indicated as mutually adjacent source lines, a source line driven with the opposite polarity is actually disposed between them, making j=(i+2).

The source driver 14-1 includes a data latch unit 21, DA conversion units 22A and 22B, sub bias units 23A and 23B, output amplifier units 24A and 24B, and a center unit 25.

The data latch unit 21 sequentially retrieves the series of pixel data pieces PD included in the video data signal VDS supplied from the timing controller 12. Every time the pixel data pieces PD of the number (m) corresponding to the gradation voltage signal to be supplied by the source driver 14-1 is retrieved from among the pixel data pieces PD for one horizontal scanning line, the data latch unit 21 supplies the retrieved pixel data pieces PD to decoders 30-1 to 30-p of the DA conversion units 22A and 22B, respectively.

The DA conversion units 22A and 22B each include a plurality of decoders that supply the gradation voltages to the output amplifier units 24A and 24B. In the embodiment, the DA conversion unit 22A includes the decoders 30-1 to 30-i. The decoders 30-1 to 30-i are decoders that corresponds to the source lines SL1 to SLi. The DA conversion units 22B includes the decoders 30-j to 30-p. The decoders 30-j to 30-p are decoders that corresponds to the source lines SLj to SLp.

The decoders 30-1 to 30-p receives a supply of the pixel data pieces PD from the data latch unit 21 and receives a supply of the gradation voltages from the center unit 25 via the gradation wiring GW. Each of the decoders 30-1 to 30-p selects at least one gradation voltage corresponding to the luminance indicated by the pixel data piece PD received by itself from among the gradation voltages supplied via the gradation wiring GW, and supplies the gradation voltage to the output amplifier units 24A and 24B.

The sub bias units 23A and 23B are bias current adjustment units that adjust an amount of current of a bias current flowing inside the output amplifier in order to operate the respective output amplifiers inside the output amplifier units 24A and 24B. Such adjustment of the bias current is performed in order to adjust drive capabilities of the output amplifiers constituting the output amplifier units 24A and 24B.

The sub bias units 23A and 23B are disposed at opposed positions across the center unit 25 (in the embodiment, on the left and right sides across the center unit 25). The sub bias unit 23A adjusts the bias current of the output amplifiers located on the left side with respect to the center unit 25, namely, the output amplifiers 40-1 to 40-i of the output amplifier unit 24A. This adjusts the drive capabilities of the output amplifiers 40-1 to 40-i and corrects an output delay (a slew rate). The sub bias unit 23B adjusts the bias current of the output amplifiers located on the right side with respect to the center unit 25, namely, the output amplifiers 40-j to 40-p of the output amplifier unit 24B. This adjusts the drive capabilities of the output amplifiers 40-j to 40-p and corrects the output delay (the slew rate).

The output amplifier unit 24A includes the output amplifiers 40-1 to 40-i disposed corresponding to the source lines SL1 to SLi. The output amplifier unit 24B includes the output amplifiers 40-j to 40-p disposed corresponding to the source lines SLj to SLp. Output terminals T1 to Ti of the output amplifiers 40-1 to 40-i are connected to the source lines SL1 to SLi, respectively. Output terminals Tj to Tp of the output amplifiers 40-j to 40-p are connected to the source lines SLj to SLp, respectively.

Each of the output amplifiers 40-1 to 40-i and the output amplifiers 40-j to 40-p (hereinafter referred to as the output amplifiers 40-1 to 40-p) is so-called a voltage follower circuit constituted of an operational amplifier, for example, an output terminal itself is connected to its inverting input terminal (−). By receiving each gradation voltage output from the decoders 30-1 to 30-p at each non-inverting input terminal (+) and amplifying and outputting a voltage corresponding to the gradation voltage that each non-inverting input terminal (+) has received to its output terminal, the output amplifiers 40-1 to 40-p generate data signals Vd1 to Vdp corresponding to each gradation voltage. The data signals Vd1 to Vdp are supplied to the source lines SL1 to SLp of the display panel 11 as pixel drive signals. In the embodiment, each of the output amplifiers 40-1 to 40-p outputs each of the data signals Vd1 to Vdp at a timing when a signal level of an output start signal LOAD generated by a data processing unit (not illustrated) based on the frame synchronizing signal FS changes.

The center unit 25 is disposed in a region close to the center portion of the driver IC that constitutes the source driver 14-1. The DA conversion units 22A and 22B, the sub bias units 23A and 23B, and the output amplifier units 24A and 24B are each disposed at the opposed positions (in the embodiment, on the left and right sides) across the center unit 25. The center unit 25 includes a comparison unit 26, a bias unit 27, and a gradation voltage generation unit 28.

The comparison unit 26 compares the data signal Vdi output from the output amplifier 40-i, which is disposed at a position closest to the center unit 25 among the output amplifiers constituting the output amplifier unit 24A, with the data signal Vdj output from the output amplifier 40-j, which is disposed at the position closest to the center unit 25 among the output amplifiers constituting the output amplifier unit 24B. In the embodiment, the respective signal levels (the voltage values) of the data signal Vdi and the data signal Vdj are compared, and the sub bias units 23A and 23B are controlled based on a comparison result.

The bias unit 27 generates the bias current to be supplied to the output amplifiers 40-1 to 40-p. The bias currents generated by the bias unit 27 are supplied to the output amplifiers 40-1 to 40-p after being adjusted by the sub bias units 23A and 23B.

The gradation voltage generation unit 28 generates the gradation voltages that represent the luminance level that can be displayed on the display panel 11 in 256 gradations, and supplies them to each of the decoders 30-1 to 30-p via the gradation wirings GW.

The gradation wiring GW extends along a direction (a first direction) in which the output amplifiers 40-1 to 40-p are arranged side by side. The gradation voltage generation unit 28 that outputs the gradation voltages to the gradation wiring GW is disposed in the center unit 25 that is the region located at the center portion in the first direction. Accordingly, the output amplifiers 40-i and 40-j disposed at the opposed positions with the center unit 25 interposed between them are ideally located at equal distances from the gradation voltage generation unit 28. However, in reality, the gradation voltage generation unit 28 is not necessarily arranged at the position equidistant from the output amplifiers 40-i and 40-j, and thus, lengths of the gradation wirings GW from the gradation voltage generation unit 28 to each output amplifier are different. In view of this, due to an electrical resistance difference and a capacitance difference in wiring resistance based on the difference in length, a difference in the signal level occurs between the data signal Vdi output from the output amplifier 40-i and the data signal Vdj output from the output amplifier 40-j. Thus, a time difference occurs in the time until the signal level of each data signal reaches a target voltage, causing display unevenness on the display panel 11. The sub bias units 23A and 23B of the embodiment performs the adjustment of the bias current in order to adjust such difference in the outputs of the output amplifiers.

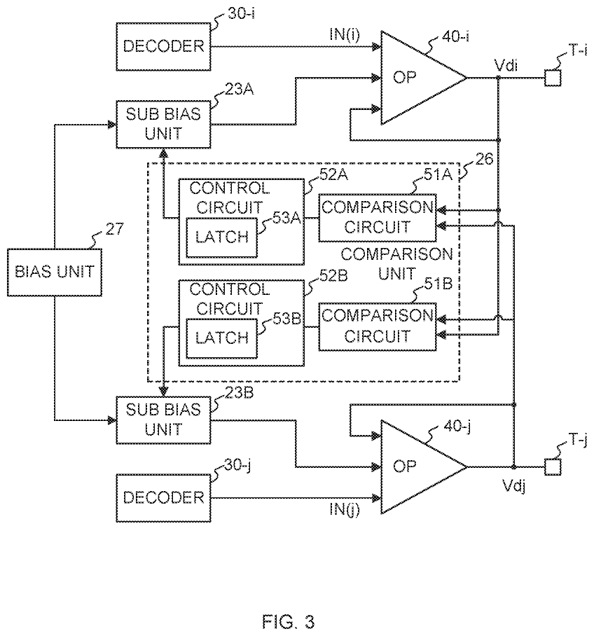

FIG. 3 is a circuit diagram illustrating the configuration of the comparison unit 26 and its periphery. Here, output amplifiers 40-i and 40-j that are output amplifiers disposed at closest positions from the center unit 25 and disposed at the opposed positions across the center unit 25 are indicated. As described above, an output amplifier (not illustrated) that drives the source line with an opposite polarity is disposed between the output amplifiers 40-i and 40-j, and in the embodiment, j=(i+2).

The comparison unit 26 includes comparison circuits 51A and 51B and control circuits 52A and 52B.

The comparison circuit 51A compares the respective signal levels (the voltage values) of the data signal Vdi output from the output amplifier 40-i and the data signal Vdj output from the output amplifier 40-j. The comparison circuit 51A supplies a comparison result to the control circuit 52A.

The comparison circuit 51B compares the respective signal levels (the voltage values) of the data signal Vdj output from the output amplifier 40-j and the data signal Vdi output from the output amplifier 40-i. The comparison circuit 51B supplies a comparison result to the control circuit 52B.

The control circuit 52A includes a latch circuit 53A that retrieves the comparison result of the comparison circuit 51A. The control circuit 52A controls the sub bias unit 23A based on the comparison result retrieved by the latch circuit 53A.

The control circuit 52B includes a latch circuit 53B that retrieves the comparison result of the comparison circuit 51B. The control circuit 52B controls the sub bias unit 23B based on the comparison result retrieved by the latch circuit 53B.

The control circuits 52A and 52B are in advance set such that only any one of them controls the sub bias unit (23A or 23B) to cause it to execute the adjustment of the bias current, and the other stops the operation of the sub bias unit (23A or 23B) corresponding to the comparison results by the comparison circuits 51A and 51B. For example, in the embodiment, the control circuits 52A and 52B perform the control of the sub bias units 23A and 23B such that they cause the sub bias unit that corresponds to the output amplifier the voltage value of the data signal Vd of which is relatively lower to execute a bias current adjustment operation, and they stop the operation of the sub bias unit that corresponds to the output amplifier the voltage value of which is relatively higher. As a result, the bias current is adjusted in a direction of increasing the drive capability of the output amplifier the voltage value of the data signal Vd of which is relatively lower, and the time difference until the data signal Vd reaches a predetermined target electric potential, namely, the output delay is corrected.

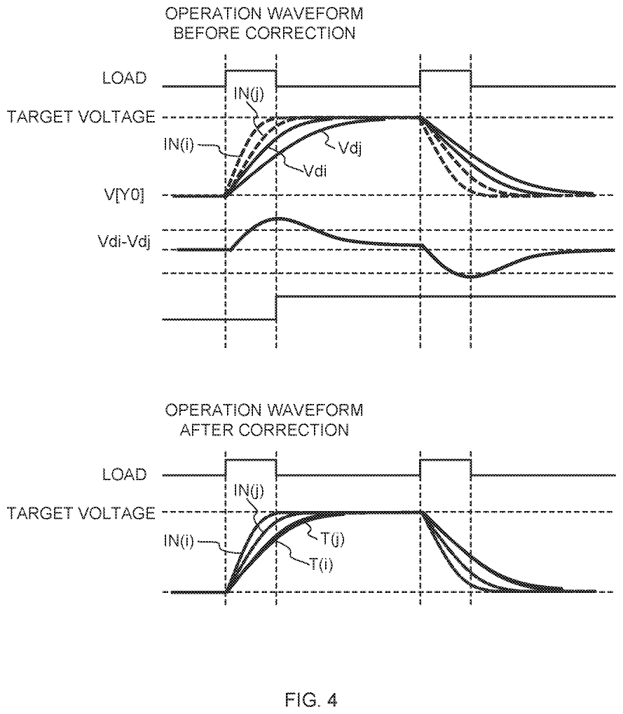

FIG. 4 is a diagram illustrating operation waveforms of the input signals and the output signals of the output amplifiers 40-i and 40-j in respective states before correction of the output delay and after correction of the output delay. Here, the gradation voltages supplied to the output amplifiers 40-i and 40-j from the decoders 30-i and 30-j are indicated as input signals IN(i) and IN(j), respectively.

The comparison circuits 51A and 51B compare the output signal (Vdi) of the output amplifier 40-i with the output signal (Vdj) of the output amplifier 40-j at a fall point of the output start signal LOAD. As illustrated in an upper row in FIG. 4, at the fall point of the output start signal LOAD, the voltage value of the data signal Vdj is lower than the voltage value of the data signal Vdi. Since a rise of the data signal Vdj is slower than the rise of the data signal Vdi, a difference also occurs in the time it takes to reach the target voltage.

Since the voltage value of the data signal Vdi is lower than the voltage value of the data signal Vdi at the fall point of the output start signal LOAD, the control circuit 52B controls the sub bias unit 23B to cause it to execute the adjustment of the bias current.

By such adjustment of the bias current, as illustrated in a lower row in FIG. 4, the drive capability of the output amplifier 40-j is adjusted such that the signal waveform of the data signal Vdj, which is the output signal of the output amplifier 40-j, becomes close to the signal waveform of the data signal Vdi, which is the output signal of the output amplifier 40-i. As a result, the output delay (the slew rate) of the output amplifier 40-j is corrected, and the time difference until reaching the target voltage becomes smaller.

As illustrated in FIG. 2, the sub bias unit 23B is configured to be able to perform the adjustment of the bias current for each of the output amplifiers 40-j to 40-p included in the output amplifier unit 24B. Arrangement intervals of each of the output amplifiers 40-j to 40-p are known (for example, equal distances), and the sub bias unit 23B can also perform the adjustment of the bias current for the output amplifiers other than the output amplifier 40-j among the output amplifiers 40-j to 40-p based on an adjustment value of the bias current for the data signal Vdj.

On the other hand, different from the example illustrated in FIG. 4, when, at the fall point of the output start signal LOAD, the voltage value of the data signal Vdi is lower than the voltage value of the data signal Vdj, the control circuit 52A controls the sub bias unit 23A to cause it to execute the adjustment of the bias current. Based on the adjustment value of the bias current, the sub bias unit 23A performs the adjustment of the bias current also for the output amplifiers other than the output amplifier 40-i among the output amplifiers 40-1 to 40-i.

As described above, the source driver of the embodiment allows adjusting the output of the output amplifier for each channel and correcting the time difference until the data signal output from each output amplifier reaches the target voltage. This makes it possible to suppress the occurrence of the display unevenness in the channel direction of the display panel.

### Embodiment 2

Next, Embodiment 2 of the disclosure will be described. The source driver of this embodiment is different from the source driver 14-1 of Embodiment 1 in the configuration and the operation of the comparison unit.

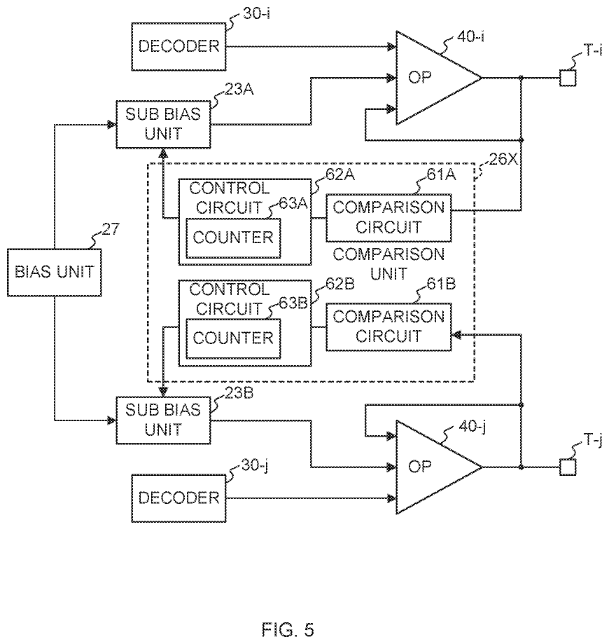

FIG. 5 is a circuit diagram illustrating configurations of a comparison unit 26X and its periphery of Embodiment 2. Here, similarly to Embodiment 1, the output amplifiers 40-i and 40-j that are output amplifiers disposed at the closest positions from the center unit 25 and disposed at the opposed positions across the center unit 25 are indicated.

The comparison unit 26X includes comparison circuits 61A and 61B, and control circuits 62A and 62B.

The comparison circuit 61A compares the data signal Vdi output from the output amplifier 40-i with a reference voltage value VREF. For example, the comparison circuit 61A outputs a detection signal P(i) that changes from a logic level 0 to a logic level 1 at a timing when a signal level (the voltage value) of the data signal Vdi exceeds the reference voltage value VREF, and supplies it to the control circuit 62A.

The comparison circuit 61B compares the data signal Vdj output from the output amplifier 40-j with the reference voltage value VREF. For example, the comparison circuit 61B outputs a detection signal P(j) that changes from a logic level 0 to a logic level 1 at a timing when a signal level (the voltage value) of the data signal Vdj exceeds the reference voltage value VREF, and supplies it to the control circuit 62B.

The control circuit 62A includes a counter 63A that performs counting corresponding to a clock timing of the clock signal CLK. The control circuit 62A controls the sub bias unit 23A based on the detection signal P(i) supplied from the comparison circuit 61A and a count value of the counter 63A. Specifically, the control circuit 62A controls the sub bias unit 23A according to whether the count value at a timing of a signal change of the detection signal P(i) is earlier or later than a predetermined reference count value, thus causing the sub bias unit 23A to execute the adjustment of the bias current.

The control circuit 62B includes a counter 63B that performs counting corresponding to the clock timing of the clock signal CLK. The control circuit 62B controls the sub bias unit 23B based on the detection signal P(j) supplied from the comparison circuit 61B and a count value of the counter 63B. Specifically, the control circuit 62B controls the sub bias unit 23B based on whether the count value at the timing of the signal change of the detection signal P(j) is earlier or later than a predetermined reference count value, thus causing the sub bias unit 23B to execute the adjustment of the bias current.

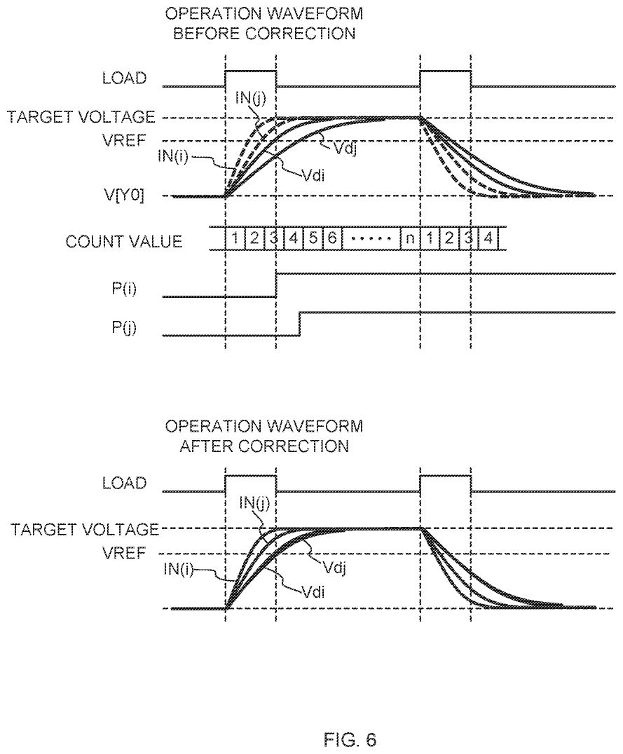

FIG. 6 is a diagram illustrating the operation waveforms of the input signals and the output signals of the output amplifiers 40-i and 40-j in respective states before correction of the output delay and after correction of the output delay. Here, the gradation voltages supplied to the output amplifiers 40-i and 40-j from the decoders 30-i and 30-j are indicated as input signals IN(i) and IN(j), respectively.

The counters 63A and 63B start counting in response to a timing of a rise of the output start signal LOAD. The comparison circuit 61A compares the data signal Vdi that is the output signal of the output amplifier 40-i with the reference voltage value VREF, and outputs the detection signal P(i) that changes from the logic level 0 to the logic level 1 at the timing when the data signal Vdi exceeds the reference voltage value VREF. Here, since the data signal Vdi exceeds the reference voltage value VREF at a stage of a count value “3”, the detection signal P(i) becomes a signal that changes from the logic level 0 to the logic level 1 at the timing of the count value “3.”

Similarly, the comparison circuit 61B compares the data signal Vdj that is the output signal of the output amplifier 40-j with the reference voltage value VREF, and outputs the detection signal P(j) that changes from the logic level 0 to the logic level 1 at the timing when the data signal Vdj exceeds the reference voltage value VREF. Here, since the data signal Vdj exceeds the reference voltage value VREF at a stage of a count value “4”, the detection signal P(j) becomes a signal that changes from the logic level 0 to the logic level 1 at the timing of the count value “4.”

The control circuits 62A and 62B control the sub bias units 23A and 23B to cause them to execute the adjustment of the bias current so as to match the drive capability of one output amplifier of the output amplifiers 40-i and 40-j to the drive capability of the other output amplifier. For example, in the example illustrated in FIG. 6, since the timing at which the data signal Vdj exceeds the reference voltage value VREF is relatively late, the control circuit 62B controls the sub bias unit 23B to perform the adjustment of the bias current in a direction of increasing the drive capability of the output amplifier 40-j.

By such adjustment of the bias current, as illustrated in a lower row in FIG. 6, the drive capability of the output amplifier 40-j is adjusted such that the signal waveform of the data signal Vdj, which is the output signal of the output amplifier 40-j, becomes close to the signal waveform of the data signal Vdi, which is the output signal of the output amplifier 40-i. As a result, the output delay (the slew rate) of the output amplifier 40-j is corrected, and the time difference until reaching the target voltage becomes smaller.

On the contrary, the control circuit 62A may control the sub bias unit 23A to perform the adjustment of the bias current in a direction of decreasing the drive capability of the output amplifier 40-i.

As described above, the source driver 14-1 of this embodiment detects the timing at which the data signal Vdi output from the output amplifier 40-i and the data signal Vdj output from the output amplifier 40-j each exceed the reference voltage value VREF, and performs the control of the bias current of each output amplifier based on its detection result. In other words, in Embodiment 1, while the comparison unit 26 directly compares the voltage values of the data signals Vdi and Vdj, in this embodiment, the comparison unit 26X compares the timings at which each of the data signals Vdi and Vdj exceeds the reference voltage value VREF. Accordingly, since, instead of adjusting the bias current for any one of the output amplifiers 40-i and 40-j, the bias currents can be adjusted for both the output amplifiers 40-i and 40-j, the adjustment of the output delay (the slew rate) can be performed in more detail.

According to the source driver of this embodiment, by precisely adjusting the outputs of the output amplifiers for each channel, it is possible to correct the time difference until the data signal output from each output amplifier reaches the target voltage and to suppress the occurrence of the display unevenness in the channel direction of the display panel.

The disclosure is not limited to the above-described embodiment. For example, in each embodiment described above, the case where the display apparatus 100 is the liquid crystal display apparatus of the active matrix system has been described as an example. However, the display apparatus 100 may be an organic EL (OLED) display apparatus. In this case, the relationship between “i” and “j” in each embodiment described above is j=(i+1), and the output amplifiers 40-i and 40-j become the output amplifiers corresponding to the source line SLi and the source line SLj, which are mutually adjacent to one another.

In each embodiment described above, the case where the comparison unit 26 compares the data signals Vd output from each of the output amplifiers 40-i and 40-j disposed at the positions closest to the center unit 25 has been described as an example. However, comparison targets are not necessarily limited to the output amplifiers at the positions closest to the center unit 25, and it is only necessary that the comparison targets are ones that are the output data of the output amplifiers disposed at the opposed positions with the center unit 25 interposed therebetween. By comparing the data signals output from a pair of output amplifiers (namely, a pair of output amplifiers the gradation wirings GW of which ideally have the identical electric resistance values) that are assumed to have identical lengths of gradation wirings GW from the gradation voltage generation unit 28 to each output amplifier and adjusting the bias current of each output amplifier based on a comparison result, it is possible to correct the output delay.

In each embodiment described above, the case where the sub bias unit 23A is disposed corresponding to the output amplifier unit 24A, the sub bias unit 23B is disposed corresponding to the output amplifier unit 24B, and the sub bias unit 23A is responsible for adjusting the bias currents of the output amplifiers 40-1 to 40-i of the output amplifier unit 24A, the sub bias unit 23B is responsible for adjusting the bias currents of the output amplifiers 40-j to 40-p of the output amplifier unit 24B has been described as an example. However, the number of sub bias units is not limited thereto. A plurality of the sub bias units may be disposed corresponding to each of the output amplifier units 24A and 24B, and each sub bias unit may perform the adjustment of the bias currents for a plurality of groups into which the output amplifiers 40-1 to 40-i and the output amplifiers 40-j to 40-p are divided.

What is claimed is:

1. A source driver connected to a display panel having a plurality of source lines and a plurality of pixel portions connected to the plurality of source lines, the source driver receiving a video data signal including a series of a plurality of pixel data pieces and outputting pixel drive voltages applied to the plurality of pixel portions based on the video data signal, the source driver comprising:
a gradation wiring extending in a first direction;
a plurality of output amplifiers arranged side by side in parallel with the gradation wiring along the first direction, the output amplifiers receiving supply of gradation voltages via the gradation wiring, generating the pixel drive voltages based on the video data signal and the gradation voltages, and outputting to the plurality of source lines;
a gradation voltage generation unit that is disposed in a center region located close to a center portion of a driver IC constituting the source driver and generates the gradation voltages to output to the gradation wiring;
a bias current supply unit that is disposed in the center region and supplies bias currents to the plurality of output amplifiers;
a comparison unit that compares the pixel drive voltages output from each of a first output amplifier and a second output amplifier disposed at opposed positions across the center region among the plurality of output amplifiers; and
a bias current adjustment unit that adjusts at least one of the bias current supplied to the first output amplifier and the bias current supplied to the second output amplifier based on a comparison result of the comparison unit.

2. The source driver according to claim 1, wherein
the comparison unit compares a voltage value of the pixel drive voltage output from the first output amplifier with a voltage value of the pixel drive voltage output from the second output amplifier at a predetermined timing after the plurality of output amplifiers start outputting the pixel drive voltages.

3. The source driver according to claim 1, wherein
the comparison unit compares a timing when the voltage value of the pixel drive voltage output from the first output amplifier exceeds a reference voltage value with a timing when a voltage value of the pixel drive voltage output from the second output amplifier exceeds the reference voltage value.

4. The source driver according to claim 1, wherein
the first output amplifier and the second output amplifier are output amplifiers that output the pixel drive voltages of a first polarity and are the output amplifiers that supply the pixel drive voltages to the respective source lines disposed at adjacent positions among p (p is an integer equal to or more than 2) source lines that receive the supply of the pixel drive voltages of the first polarity among the plurality of source lines.

5. A display apparatus comprising:
a display panel having a plurality of source lines and a plurality of source lines, and a plurality of pixel portions disposed in a matrix at respective intersecting portions between the plurality of source lines and the plurality of source lines; and
a source driver that receives a video data signal including a series of a plurality of pixel data pieces and outputs pixel drive voltages applied to the plurality of pixel portions based on the video data signal, wherein
the source driver includes:
a gradation wiring extending in a first direction;
a plurality of output amplifiers arranged side by side in parallel with the gradation wiring along the first direction, the output amplifiers receiving supply of gradation voltages via the gradation wiring, generating the pixel drive voltages based on the video data signal and the gradation voltages, and outputting to the plurality of source lines;
a gradation voltage generation unit that is disposed in a center region located close to a center portion of a driver IC constituting the source driver and generates the gradation voltages to output to the gradation wiring;
a bias current supply unit that is disposed in the center region and supplies bias currents to the plurality of output amplifiers;
a comparison unit that compares the pixel drive voltages output from each of a first output amplifier and a second output amplifier disposed at opposed positions across the center region among the plurality of output amplifiers; and
a bias current adjustment unit that adjusts at least one of the bias current supplied to the first output amplifier and the bias current supplied to the second output amplifier based on a comparison result of the comparison unit.
